(19) United States
(12) Patent Application Publication
(10) Pub. No.: US 2024/0428346 A1
(43) Pub. Date: Dec. 26, 2024

(54) Systems and Methods for Rewarding Content Creators on Social Media Platforms

(71) Applicant: INMO, LLC, Birmingham, AL (US)

(72) Inventors: Blake Patterson, Birmingham, AL (US); Adelaide Matte, Birmingham, AL (US); Geran de Klerk, Cape Town (ZA)

(21) Appl. No.: 18/650,716

(22) Filed: Apr. 30, 2024

Related U.S. Application Data
(60) Provisional application No. 63/522,083, filed on Jun. 20, 2023.

(51) Int. Cl. G06Q 50/00

(52) U.S. Cl. CPC G06Q 50/01

(57) ABSTRACT

Systems and methods are disclosed herein for generating and displaying a leaderboard user interface. The systems and methods can display a leaderboard user interface on social media platforms. Content creators can upload input data through computers of the system, and consumers can interact with the input data through computers of the system. The systems and methods can determine the amount of consumer interaction with the input data and reward content creators with a leaderboard ranking based on the quality of the consumer interactions with the input data uploaded by each content creator. The systems and methods can reward content creators with high leaderboard rankings by displaying the leaderboard user interface and allowing users of the platform to directly access information about the content creators with high leaderboard rankings on the leaderboard user interface.

All patents, patent applications, and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure, as it appears in the U.S. Patent and Trademark Office patent file or records, but otherwise reserves any and all copyright rights.

### FIELD OF THE INVENTION

The present disclosure is directed to a digital platform with a leaderboard functionality.

### CROSS-REFERENCE TO RELATED APPLICATIONS

This application claims priority to and the benefit of U.S. Provisional Patent Application No. 63/522,083, entitled “Systems and Methods for Rewarding Content Creators on Social Media Platforms,” filed Jun. 20, 2023, which is incorporated by reference in its entirety.

### BACKGROUND

The present disclosure generally relates to systems and methods for a digital platform with a leaderboard functionality, and more particularly to a social media platform for content creators. Current social media platforms do not reward original content and can cause content creators to regurgitate content rather than create something original, especially when original content does not earn the growth and engagement that the content creators are hoping for. What is needed is a platform that is configured to heighten the reward for content creators posting original content.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The present disclosure relates to generating and displaying a leaderboard user interface, and more particularly to systems and methods for incentivizing originality by rewarding a user with a high leaderboard ranking for creating and sharing original or well-received content. Current social media platforms do not reward original content and can cause content creators to regurgitate content rather than create something original, especially when original content does not earn the growth and engagement that the content creators are hoping for. What is needed is a platform that is configured to heighten the reward for content creators posting original content. In particular, originality can be encouraged by rewarding a content creator with a high leaderboard ranking, such as in response to the quantity of interactions with a content creator's input data, the quality of interactions with the content creator's input data, or a combination thereof.

Content creators can be rewarded in a manner proportional to the quality of interactions a consumer has with the particular input data, such as the amount of originality or creativity in the input data. For example, the number of interactions with a content creator's input data can be compared to the number of interactions with posts by other content creators, and content creators with a higher number of interactions can be ranked on the leaderboard above content creators with a lower number of interactions. The leaderboard may be configured such that users of the digital platform can directly access a particular post, a content creator's profile, or both by clicking on the post, the content creator's profile, or both as displayed on the leaderboard. A digital platform can operate to allow for the exchange of information between users of the platform, such as a social media platform with users comprising content creators, content consumers, or a combination thereof.

One aspect of the disclosure is a system having at least one memory with non-transitory computer-executable instructions stored thereon. The system may include a first computer with at least one processor for executing the non-transitory computer-executable instructions, a second computer with one or more input devices, and a third computer comprising one or more audio output devices, video output devices, or a combination thereof. The non-transitory computer-executable instructions, when executed by the first computer, may cause the first computer to perform one or more operations. The one or more operations may include providing a first web-based portal accessible by the second computer, wherein the first web-based portal is configured to display a first graphical user interface on the second computer, and wherein the first graphical user interface comprises a means for each content creator of a plurality of content creators to upload input data. The operations may include providing a second web-based portal accessible by the third computer, and wherein the second web-based portal is configured to display a second graphical user interface on the third computer, and wherein the second graphical user interface comprises a means for a consumer from among a plurality of consumers to receive the input data and a means for the consumer to interact with the input data. The operations may include determining a number of consumer interactions with the input data uploaded by each content creator of the plurality of content creators. The operations may include providing a leaderboard rank value for each content creator of the plurality of content creators based on the number of consumer interactions. The operations may include displaying the leaderboard rank value on a leaderboard user interface through the first web-based portal, the second web-based portal, or a combination thereof, wherein a higher leaderboard rank value receives more recognition than a lower leaderboard rank value.

Another aspect of the disclosure is a system having at least one memory with non-transitory computer-executable instructions stored thereon. The system may include a first computer with at least one processor for executing the non-transitory computer-executable instructions, and a second computer with one or more input devices. The non-transitory computer-executable instructions, when executed by the second computer, may cause the second computer to perform one or more operations. The one or more operations may include accessing a web-based portal configured to display a graphical user interface on the second computer, the graphical user interface comprising a means for each content creator of a plurality of content creators to upload input data. The operations may include displaying, on the graphical user interface, an option for each content creator of the plurality of content creators to upload the input data. The operations may include receiving, from the first computer, the input data uploaded by each content creator of the plurality of content creators. The operations may include displaying, via the graphical user interface, a leaderboard rank value on a leaderboard user interface through the web-based portal, wherein a higher leaderboard rank value receives more recognition than a lower leaderboard rank value based on a number of consumer interactions with the input data uploaded by each content creator of the plurality of content creators.

Another aspect of the disclosure is a system having at least one memory with non-transitory computer-executable instructions stored thereon. The system may include a first computer with at least one processor for executing the non-transitory computer-executable instructions, a second computer with one or more input devices, and a third computer comprising one or more audio output devices, video output devices, or a combination thereof. The non-transitory computer-executable instructions, when executed by the third computer, may cause the third computer to perform one or more operations. The one or more operations may include accessing a web-based portal configured to display a graphical user interface on the third computer, the graphical user interface comprising a means for a consumer from among a plurality of consumers to receive input data uploaded by a plurality of content creators and a means for the consumer to interact with the input data. The operations may include receiving, from the first computer, the input data uploaded by a content creator from among the plurality of content creators. The operations may include outputting, via the one or more audio output devices, video output devices, or a combination thereof, the input data uploaded by the content creator. The operations may include displaying, via the graphical user interface, the means for the consumer to interact with the input data uploaded by the content creator. The operations may include receiving at least one consumer interaction with the input data uploaded by the content creator. The operations may include displaying, via the graphical user interface, a leaderboard rank value on a leaderboard user interface through the web-based portal, wherein a higher leaderboard rank value receives more recognition than a lower leaderboard rank value based at least in part on the at least one consumer interaction with the input data uploaded by the content creator.

Numerous other objects, advantages and features of the present disclosure will be readily apparent to those of skill in the art upon a review of the following drawings and description of various embodiments.

### BRIEF DESCRIPTION OF THE DRAWINGS

The accompanying drawings, which are incorporated in and constitute a part of the specification, illustrate exemplary embodiments of the disclosure. Together with the description, they serve to explain the objects, advantages, and principles of the disclosure. In the drawings:

FIG. 1 is a schematic block diagram depicting one embodiment of a system of the present disclosure.

FIG. 2 is a schematic block diagram depicting one embodiment of a system of the present disclosure.

FIGS. 3A-3B are schematic block diagrams depicting example embodiments of a system of the present disclosure.

FIGS. 4A-4E provide serial views of a social media platform under one embodiment of the present disclosure.

FIG. 4F-4G illustrate a leaderboard user interface under one embodiment of the present disclosure.

FIG. 5 is a flowchart diagram depicting one embodiment of a method of the present disclosure.

FIG. 6 is a flowchart diagram depicting one embodiment of a method of the present disclosure.

FIG. 7 is a flowchart diagram depicting one embodiment of a method of the present disclosure.

### DETAILED DESCRIPTION

Reference will now be made in detail to exemplary embodiments of the disclosure, some aspects of which are illustrated in the accompanying drawings.

In various embodiments, the present disclosure relates to a digital platform with a leaderboard functionality. This disclosure further relates to systems that transfer digital assets, such as non-fungible tokens (NFTs), between one or more parties. In particular, this disclosure relates to systems and methods for incentivizing originality by rewarding a user with NFTs and/or a high leaderboard ranking for creating and sharing original or well-received content. The systems and methods can reward a user with NFTs or a high leaderboard ranking in response to the quantity of interactions with a user's input data, the quality of interactions with the user's input data, or a combination thereof.

The leaderboard functionality can comprise a ranking system, wherein a content creator's rank amongst other content creators can be proportional to the number of interactions with the content creator's input data (e.g., content), the quality of interactions with the content creator's input data, or a combination thereof. In embodiments, the number of interactions with the input data (also referred to, herein, as a “post”) can be compared to the number of interactions with posts by other content creators, and content creators with a higher number of interactions can be ranked on the leaderboard above content creators with a lower number of interactions. In embodiments, consumers, content creators, third-party marketing professionals, the digital platform provider, or a combination thereof can view leaderboard statistics for a given content creator. In embodiments, the leaderboard can be configured such that users (e.g., consumers) of the digital platform can directly access a particular post, a given content creator's profile, or both by clicking on the post, the given content creator's profile, or both as displayed on the leaderboard.

An interaction can comprise any means through which a consumer interacts with a content creator's post. By way of non-limiting example, the interaction can comprise a non-written notation or designation of approval by a consumer, such as a “like,” a “heart,” a “thumbs up,” or a combination thereof. In embodiments, an interaction comprises a comment by a consumer, the number of views by a consumer, the number of shares by a consumer, or a combination thereof.

In embodiments, the number of interactions for a given post (i.e., input data) can be calculated over a given time period, and rankings can be assigned at least once during the given time period. The given time period can be about up to one week. In embodiments, the given time period can be up to one day. The given time period can be about 24 hours. In embodiments, the given time period can be about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, or about 24 hours.

Some embodiments comprise incentivizing creativity or originality by rewarding content creators who create posts that receive a relatively high number of interactions as compared to other content creators. Some embodiments further permit digital platforms, consumers, or both to more readily identify content creators who create content that is well received by consumers. In certain embodiments, the leaderboard permits the creation of challenges. Such challenges can be created by the digital platform provider, content creators, consumers, or a combination thereof.

In embodiments, the leaderboard comprises a plurality of categories to permit users of the digital platform to selectively access content that relates to the particular user's interests. Non-limiting exemplary categories include the subject matter of the content, the location of the content creator, the location of the content, or a combination thereof. In embodiments, the subject matter category includes a plurality of topics that are commonly of interest to one or more users. For instance, exemplary subject matter category topics are sports, music, entertainment, consumer products, or vehicles.

The embodiments set forth below represent the necessary information to enable those skilled in the art to practice the disclosure and illustrate the best mode of practicing the disclosure. Upon reading the following description in light of the accompanying drawings, those skilled in the art will understand the concepts of the disclosure and will recognize applications of these concepts not particularly addressed herein. It should be understood that these concepts and applications fall within the scope of the disclosure and any accompanying claims.

The described systems and techniques can be performed by a system that includes a single computer or more than one computer. A computer can be a processor-controlled device, such as, by way of example, personal computers, workstations, servers, clients, mini-computers, mainframe computers, laptop computers, smartphones, tablets, a network of one or more individual computers, mobile computers, portable computers, handheld computers, palmtop computers, set-top boxes for a TV, interactive televisions, interactive kiosks, personal digital assistants, interactive wireless devices, or any combination thereof.

A computer can be a uniprocessor or multiprocessor machine. Accordingly, a computer may include one or more processors and, thus, the aforementioned system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field-programmable gate arrays (FPGAs), programmable logic devices (PLDs), gated logic, and other suitable hardware configured to perform the various functionality described throughout this disclosure.

Additionally, the computer may include one or more memories. Accordingly, the aforementioned system may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, videotapes, audio tapes, magnetic recording tracks, magnetic tunnel junction (MTJ) memory, optical memory storage, quantum mechanical storage, electronic networks, and/or other devices or technologies used to store electronic content such as programs and data.

In particular, the one or more memories may store computer-executable instructions that, when executed by the one or more processors, cause the one or more processors to implement the procedures and techniques described herein. The one or more processors can be operably associated with the one or more memories so that the computer-executable instructions can be provided to the one or more processors for execution. For example, the one or more processors can be operably associated to the one or more memories through one or more buses. Furthermore, the computer may possess or can be operably associated with input devices (e.g., a keyboard, a keypad, controller, a mouse, a microphone, a touch screen, a sensor) and output devices such as (e.g., a computer screen, printer, or a speaker).

The computer may execute an appropriate operating system such as LINUX®, UNIX®, MICROSOFT® WINDOWS®, APPLER MACOS®, IBM® OS/2®, ANDROID, and PALM® OS, and/or the like. The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator can be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices can be used with programs constructed in accordance with some of the teachings described herein. In some embodiments, very specific computing machines, with specific functionality, can be required. Similarly, it may prove advantageous to construct a specialized apparatus to perform the method steps described herein by way of dedicated systems with hard-wired logic or programs stored in nonvolatile memory, such as, by way of example, read-only memory (ROM).

In some embodiments, features of the systems can be implemented primarily in hardware using, for example, hardware components such as application-specific integrated circuits (ASICs) or field-programmable gated arrays (FPGAs). Implementation of the hardware circuitry will be apparent to persons skilled in the relevant art(s). In yet another embodiment, features of the systems can be implemented using a combination of both general-purpose hardware and software.

In some embodiments, the systems and methods disclosed herein are used to transfer digital assets. A digital asset is any information that can be stored, transmitted, interpreted, and used that is encoded in a numeric format, including but not limited to information encoded as binary data. Generally, digital assets are stored in binary format, but other non-binary forms of encoding and storage can be known or developed for creating digital assets. Examples of digital assets include but are not limited to digital documents, audio, video, text, executable code in various formats, and any other type of information. Digital assets are not limited by the means of storage or transport, which can be electronic, optical, or other types of storage or transport mechanisms existing or to be developed in the future.

In embodiments, the systems and methods comprise a digital platform for exchanging information between users of the platform. For instance, the digital platform can comprise a social media platform and the users of the platform can comprise content creators, content consumers, or a combination thereof. In certain embodiments, content creators are incentivized to create content, such as input data, for the consumers. Content creators can be rewarded by the number of interactions a consumer has with the particular input data created by the content creator. Content creators can be rewarded in a manner proportional to the quality of interactions a consumer has with the particular input data. In certain embodiments, content creators are rewarded for the amount of originality or creativity in the input data.

A blockchain, as used herein, can refer to a peer-to-peer, electronic ledger which is implemented as a computer-based decentralized, distributed computer-implemented system made up of blocks which, in turn, are made up of transactions. Each transaction is a data structure that encodes the transfer of control of a digital asset between participants in the blockchain computer-implemented system and includes at least one input and at least one output. Each block contains a hash of the previous block so that blocks become chained together to create a permanent, unalterable record of all transactions which have been recorded to the blockchain since its inception. Transactions contain small programs, known as scripts, embedded into their inputs and outputs, which specify how and by whom the outputs of the transactions can be accessed.

For a transaction to be recorded to the blockchain, it must be “validated.” Network nodes (miners) perform work to ensure that each transaction is valid, with invalid transactions rejected from the network. Software clients installed on the nodes perform this validation work on an unspent transaction by executing its locking and unlocking scripts. If execution of the locking and unlocking scripts evaluates to TRUE, the transaction is valid and the transaction is recorded to the blockchain. Thus, for a transaction to be recorded to the blockchain, it should be i) validated by the first node that receives the transaction-if the transaction is validated, the node relays it to the other nodes in the network; and ii) added to a new block built by a miner; and iii) mined, i.e., added to the public ledger of past transactions.

Blockchain can be used for the implementation of “smart contracts.” These are computer programs designed to automate the execution of the terms of a machine-readable contract or agreement. Unlike a traditional contract which would be written in natural language, a smart contract is a machine executable program that comprises rules that can process inputs to produce results, which can then cause actions to be performed dependent upon those results. In respect of commercial transactions, for example, these may involve the transfer of property rights and/or assets. Such assets may include real property, personal property (including both tangible and intangible property), digital assets, or any other type of asset. In the digital economy, there is often an expectation that exchanges and transfers will be performed in a timely manner and across vast distances. This expectation, along with practical and technical limitations, means that traditional forms of asset transfer, such as physical delivery of hardcopy of documents representing a contract, negotiable instrument, etc., or the tangible asset itself, is not desirable. Thus, smart contracts can provide enhanced control, efficiency, and speed of transfer in the digital economy.

One type of digital asset that can be transferred via a blockchain is a “token.” Tokens represent and transfer assets via the blockchain. A token serves as an identifier that allows the real-world or digital asset to be referenced from the blockchain. Similar to physical assets, the tokens that represent them may have many properties, one of which is fungibility or non-fungibility. Fungibility refers to the equivalence or interchangeability of each unit of a commodity with other units of the same commodity. Fungible tokens (FTs) are tokens that can be exchanged for any other token with the same value.

Fungible tokens (FTs) are uniform, that is, FTs of the same type are identical in specification, and each FT is identical to another FT of the same type. FTs are divisible into smaller amounts. In other words, users can own or transfer a fraction of an FT. Non-fungible tokens (NFTs), however, cannot be replaced with other tokens of the same type. NFTs represent nonfungible assets. Nonfungible assets have unique information or attributes. Each NFT is unique and differs from other tokens of the same class. In contrast to FTs, NFTs cannot be divided, as the elementary unit of the NFT is the token itself.

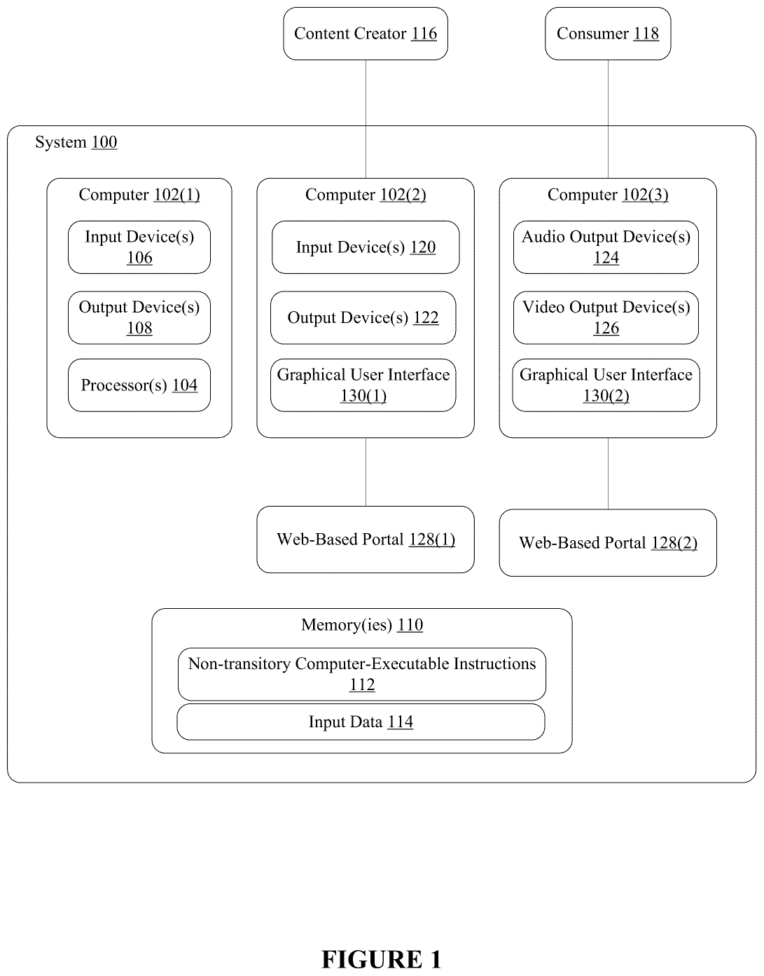

FIG. 1 is a schematic block diagram depicting one embodiment of a system 100 of the present disclosure. In embodiments, the system 100 comprises a social media platform. The system 100 can include one or more memories 110. The memories 110 can store non-transitory computer-executable instructions 112. In one aspect, the system 100 disclosed herein includes a first computer 102(1), which can be a server. The first computer 102(1) can comprise at least one processor 104. The first computer 102(1) can also comprise one or more input devices 106 and one or more output devices 108. The non-transitory computer-executable instructions 112, upon execution, can cause the first computer 102(1) to generate and transfer digital assets or perform one or more of the operations or methods described herein.

The system 100 can comprise data or data assets, such as input data 114, stored on the one or more memories 110 of the system 100. The data can include any content that is created or uploaded to the system 100 by a content creator 116 (e.g., input data 114). As used herein, the term “input data” can refer to such data created by a content creator. In embodiments, the content creator 116 uploads (via a computer, e.g., second computer 102(2)) the input data 114 for viewing consumers. The consumers can view the input data 114 on a computer (e.g., third computer 102(3)). The input data 114 can include any one or more of the following: audio data, visual data, audiovisual data, or any other forms of data that can be viewed, heard, or otherwise accessed by a consumer 118.

In embodiments, the audio data comprises an audio file that contains non-transitory computer-executable instructions that, when executed by a computer, cause the computer to play audio through an audio output device, such as a speakers or headphones. Audio files may contain (optionally only contain) non-transitory computer-executable instructions for playing audio from part of a complete song or track. For example, an audio file may only contain audio from a single instrument, such as vocals, guitar, keys, bass, or drums. An audio stem may also contain audio data from one portion of a track, such as the melody, harmony, rhythm, etc.

The visual data can include still visual images or videos. The visual data can comprise video or image files containing non-transitory computer-executable instructions that encode for various visual images, components of images, videos, or components of videos that were created by the content creator 116. Audiovisual data can include data that is a combination of visual data and audio data, which is synchronized to provide a single, cohesive viewing experience by the consumer 118. In some embodiments, the non-transitory computer-executable instructions 112 can be configured to, when executed by the first computer 102(1), cause the first computer 102(1) to generate a visual image or video using visual data. In some embodiments, the first computer 102(1) may generate a plurality of visual images or videos using the visual data.

The non-transitory computer-executable instructions 112 can be configured to, when executed by the first computer 102(1), cause the first computer 102(1) to convert certain input data 114 (such as audio data, visual data, or audiovisual data created by a content creator) into data stored on a social media platform.

In one aspect, the system 100 disclosed herein includes a second computer 102(2), which can be a user computer associated with the content creator 116. The second computer 102(2) can comprise one or more processors and one or more memories. The second computer 102(2) can also comprise one or more input devices 120 and one or more output devices 122. In another aspect, the system 100 disclosed herein includes a third computer 102(3), which can be a user computer associated with the consumer 118. The third computer 102(3) can comprise one or more processors and one or more memories. The third computer 102(3) can also comprise one or more input devices and one or more output devices, such as one or more audio output devices 124, video output devices 126, or a combination thereof.

In some embodiments, the system 100 can comprise one or more user computers (e.g., second computer 102(2), third computer 102(3)). Each user computer can comprise one or more input devices (such as a mouse or a keyboard), one or more output devices (including visual output devices (i.e., a screen), and one or more audio output devices (i.e., speakers, headphones, etc.)), or a combination thereof. The non-transitory computer-executable instructions 112 can be configured to, when executed by the first computer 102(1), cause the first computer 102(1) to provide a web-based portal 128 accessible by the one or more user computers. The web-based portal 128 can be configured to display a graphical user interface 130 on one or more user computers. For example, the non-transitory computer-executable instructions 112, when executed by the first computer 102(1), can cause the first computer 102(1) to provide a first web-based portal 128(1) accessible by the second computer 102(2) and configured to display a first graphical user interface 130(1) on the second computer 102(2) that allows the content creator 116 to upload the input data 114. Additionally, the non-transitory computer-executable instructions 112, when executed by the first computer 102(1), can cause the first computer 102(1) to provide a second web-based portal 128(2) accessible by the third computer 102(3) and configured to display a second graphical user interface 130(2) on the third computer 102(3) that allows the consumer 118 to receive the input data 114 and interact with the input data 114.

The graphical user interface 130 can be used to transmit information or data to a user, receive instructions from a user, or a combination thereof. For example, when executed by the first computer 102(1), the non-transitory computer-executable instructions 112 can cause one of the input data 114 to be displayed on one or more user computers (e.g., second computer 102(2), third computer 102(3)) via the respective graphical user interface 130. As another example, when executed by the first computer 102(1), the non-transitory computer-executable instructions 112 may allow a user to interact with the input data 114 via at least one of the user computers. In one embodiment, when executed by the first computer 102(1), the non-transitory computer-executable instructions 112 can display an option on one or more user computers (e.g., second computer 102(2)) for a user, such as a content creator 116, to upload input data 114 to the system 100.

In some embodiments, when executed by the first computer 102(1), the non-transitory computer-executable instructions may cause information, metadata, or other features of the input data 114 to be displayed via the graphical user interface 130, played over an audio output device of the one or more user computers, or a combination thereof. For example, the visual images or videos can be displayed via the graphical user interface and the audio data can be transmitted to a user via the audio output device of one or more user computers.

The non-transitory computer-executable instructions 112 may, when executed by the first computer 102(1), cause buttons or icons to be displayed on the graphical user interface 130 that, when clicked on or hovered over (such as via a computer mouse), may cause the first computer 102(1) to perform an additional operation. For example, in some embodiments, the button or icon displayed on the second graphical user interface 130(2) of the third computer 102(3) and can be an offer for a user, such as a consumer 118, to “interact” with the input data 114. Such an “interaction” can include a comment on the input data 114, sharing the input data to at least one or more additional consumers using the platform, “liking” or otherwise providing a non-written comment of approval or disapproval of the input data 114, or a combination thereof. In some embodiments, the non-transitory computer-executable instructions 112 may, when executed by the first computer 102(1), cause the first computer 102(1) to record the interactions 136 from the user computer. For example, the first computer 102(1) can record the occurrence of the interaction, the quality of the interaction, or a combination thereof, in its memory.

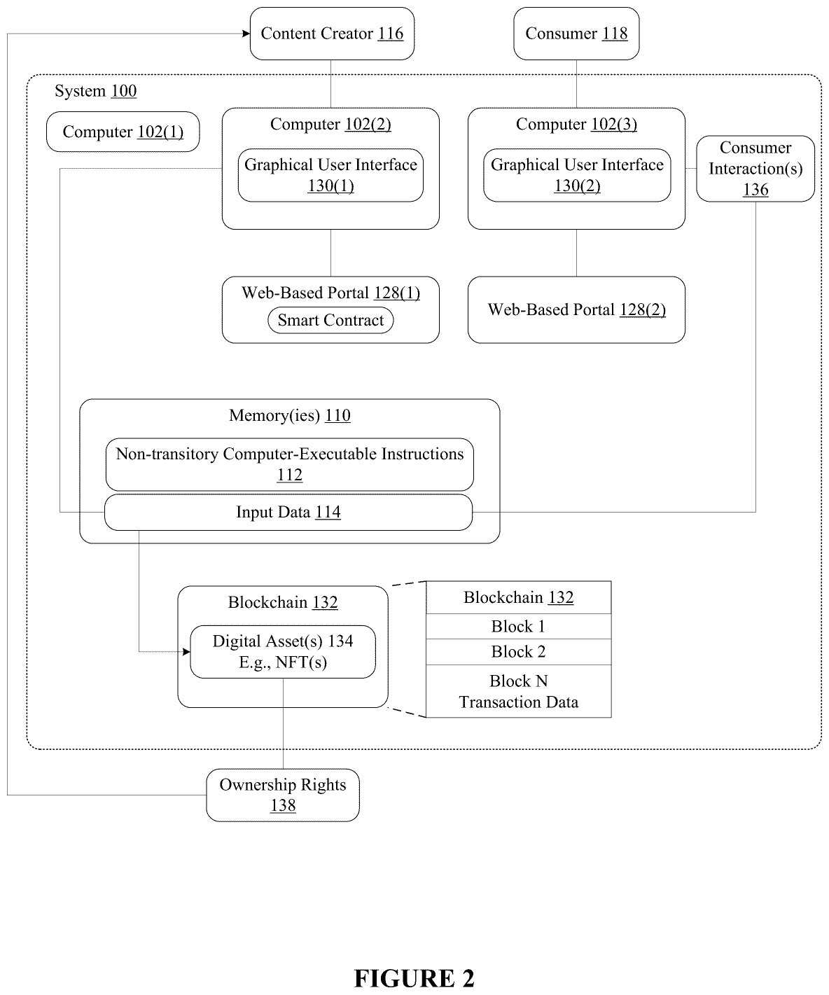

FIG. 2 is a schematic block diagram depicting one embodiment of the system 100 of the present disclosure. In certain embodiments, the first computer 102(1) can store certain data on a blockchain 132. For example, certain data can be converted or “minted” into an NFT by publishing a unique instance of the data to a blockchain. Once the data (e.g., input data 114) are converted into one or more digital assets 134 (e.g., an NFT) stored on the blockchain 132, they can become salable or transferable. The digital assets 134 may also contain metadata, such as the digital asset identification number or information about the input data 114.

In some embodiments, the creation of digital assets 134 stored on the blockchain 132 can be performed via a third-party NFT platform. In such embodiments, the first computer 102(1) can be communicably connected with the third-party platform, for example, via the internet. The non-transitory computer-executable instructions 112 of such an embodiment can be configured to, when executed by the first computer 102(1), cause the first computer 102(1) to transmit instructions to and receive data from the third-party platform. In other embodiments, the conversion of the input data 114 into one or more digital assets 134 stored on the blockchain 132 can be done directly by the system 100 without the need for a third-party platform.

The non-transitory computer-executable instructions 112 may, when executed by the first computer 102(1), cause the first computer 102(1) to assess the number of interactions 136 by the consumer 118. Further, the non-transitory computer-executable instructions 112 can be configured to, when executed by the first computer 102(1), cause the first computer 102(1) to offer or transfer ownership rights 138 in one or more of the digital assets 134 stored on the blockchain 132 to the content creator 116. In embodiments, the number of digital assets 134 offered to the content creator 116 may be directly proportional to the number of interactions 136 with the content creator's input data 114, the quality of the interactions with the input data 114, the level of creativity or originality of the input data 114, or a combination thereof.

In some embodiments, the non-transitory computer-executable instructions 112 can be configured to, when executed by the first computer 102(1), cause the first computer 102(1) to record the transfer of the ownership rights 138 in the one or more of the digital assets 134 on the blockchain 132 after a transfer of a digital asset. To do so, the first computer 102(1) may create a new block on the blockchain 132. The block may include data about the transaction, such as the date and time, price, previous owner, new owner, an identification of the digital asset, or other relevant information. The first computer 102(1) may record the transfer of the ownership rights 138 in the digital asset directly or via a third-party NFT platform.

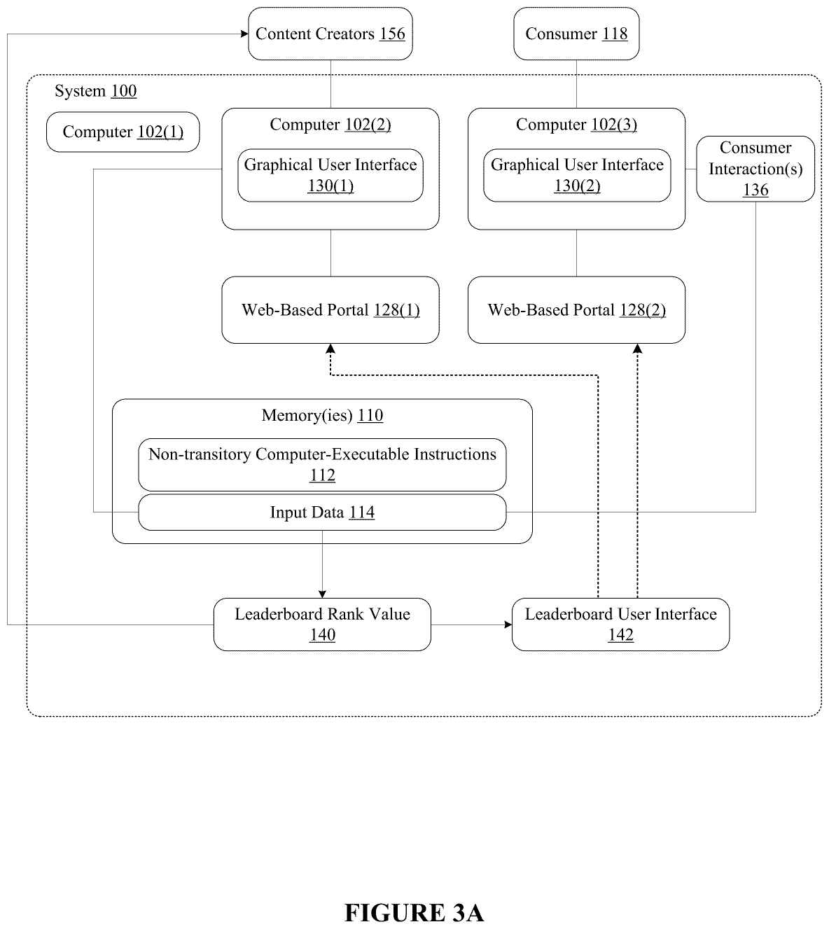

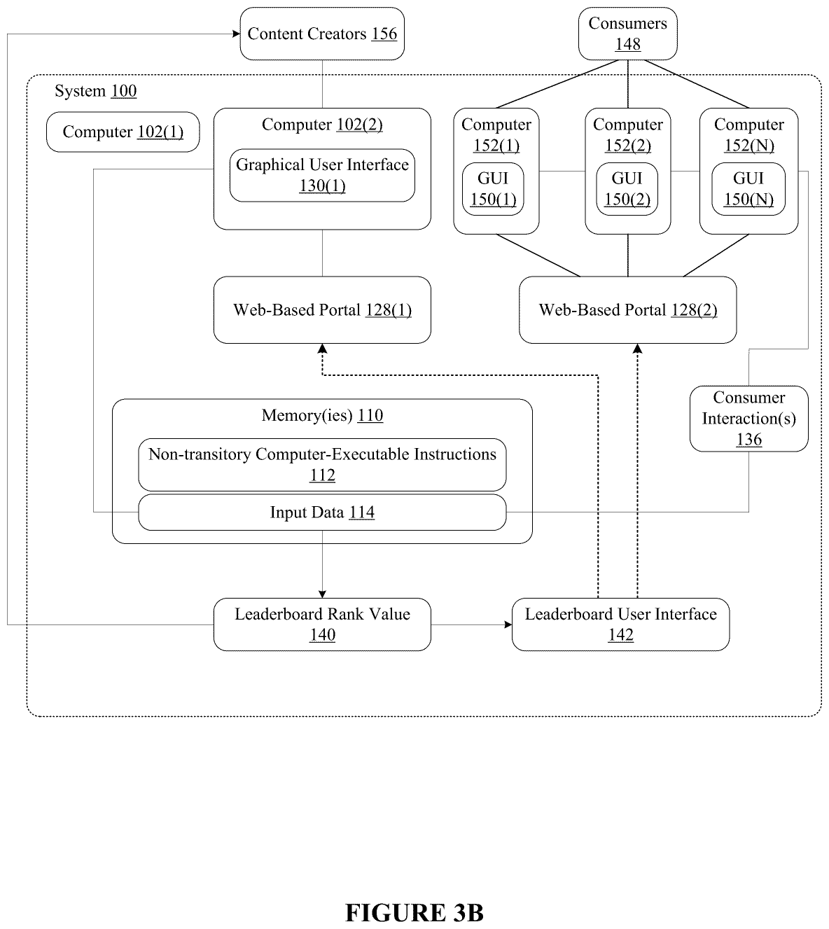

FIGS. 3A-3B are schematic block diagrams depicting example embodiments of the system 100 of the present disclosure. The non-transitory computer-executable instructions 112 may, when executed by the first computer 102(1), cause the first computer 102(1) to determine the number of consumer interactions 136 with the input data 114 uploaded by each of a plurality of content creators 156. In some embodiments, the non-transitory computer-executable instructions 112 may, when executed by the first computer 102(1), cause the first computer 102(1) to calculate the number of the consumer interactions 136 with the input data 114 uploaded by each of the content creators 156 over a predetermined period of time.

The non-transitory computer-executable instructions 112 may, when executed by the first computer 102(1), cause the first computer 102(1) to provide a leaderboard rank value 140 for each of the content creators 156 based on the number of consumer interactions 136, and display the leaderboard rank value 140 on a leaderboard user interface 142. The leaderboard rank value 140 can be assigned to the input data 114 that was uploaded by a content creator or to the content creator that uploaded the input data 114. In certain embodiments, the leaderboard rank value 140 can be provided for up to 1,000 of the content creators 156. A higher leaderboard rank value 140 for a content creator can receive more recognition that a lower leaderboard rank value 140 for another content creator, thereby incentivizing the content creators 156 to create or upload creative or original content (e.g., input data 114) to the digital platform. The leaderboard user interface 142 may be displayed through the first web-based portal 128(1), the second web-based portal 128(2), or a combination thereof.

The leaderboard user interface 142 can also display the input data 114 uploaded by the content creators 156, such as the input data 114 uploaded by the content creators with a higher leaderboard rank value 140, and/or an identifier associated with the content creators 156, such as the names of the content creators with a higher leaderboard rank value 140. The leaderboard user interface 142 may display categories, such as the subject matter of the input data 114, locations of the content creators 156, locations of the input data 114, or a combination thereof. For example, the locations of the content creators 156 with a higher leaderboard rank value 140 may be displayed along with the location and subject matter of the content creators' 156 input data 114. The categories allow users of the digital platform (e.g., consumers 148 of a social media platform) to selectively access content (e.g., input data) that relates to the particular user's interests, such as a subject matter category which may include topics that are commonly of interest to one or more users like sports, music, entertainment, consumer products, or vehicles.

In certain embodiments, the leaderboard user interface 142 can display the leaderboard rank value 140 for up to 100 of the content creators 156. In embodiments, the leaderboard user interface 142 can display the leaderboard rank value 140 for up to 90 content creators, up to 80 content creators, up to 70 content creators, up to 60 content creators, up to 50 content creators, up to 40 content creators, up to 30 content creators, up to 20 content creators, up to 10 content creators, or a combination thereof. The leaderboard user interface 142 can display the top 10 content creators, the top 5 content creators, the top 3 content creators, the top content creator, or a combination thereof.

In some embodiments, the non-transitory computer-executable instructions 112 may, when executed by the first computer 102(1), cause the first computer 102(1) to assess the number of consumer interactions 136 with the input data 114 uploaded by each content creator, a quality of the consumer interactions 136 with the input data 114 uploaded by each content creator, a level of creativity of the input data 114 uploaded by each content creator, and/or a level of originality of the input data 114 uploaded by each content creator. The resulting leaderboard rank value 140 for a content creator of the content creators 156 can be directly proportional to the number of consumer interactions 136, the quality of the consumer interactions 136, the level of creativity, the level of originality, or a combination thereof, of the input data 114 uploaded by the content creator.

Providing the leaderboard rank value 140 for each of the content creators 156 based on the number of consumer interactions 136 may include comparing the number of consumer interactions 136 with the input data 114 uploaded by each of the content creators 156 and ranking the content creators 156 based on the number of consumer interactions 136 with their input data 114. The higher leaderboard rank value 140 can be assigned to a content creator with a higher number of consumer interactions with their uploaded input data than the number of consumer interactions with the input data uploaded by another content creator. For example, the number interactions with the input data (i.e., content) uploaded by a content creator may be compared with the number of interactions with the input data uploaded by another content creator, and the content creator with a higher number of interactions with their input data may receive a higher leaderboard rank value 140 than the other content creator who may receive a lower leaderboard rank value 140.

In some embodiments, the non-transitory computer-executable instructions 112 may, when executed by the first computer 102(1), cause the first computer 102(1) to determine leaderboard statistics for each of the content creators 156 and display the leaderboard statistics for at least one of the content creators 156 on a user computing device, such as a computing device associated with one or more of a content creator, a consumer, a third-party marketer, or a digital platform provider (e.g., social media platform provider), via a web-based portal and/or graphical user interface, such as the leaderboard user interface 142.

In the example embodiment of FIG. 3A, the leaderboard user interface 142 can be displayed on a user computer via a web-based portal and provide a means for a user, such as a consumer 118, to be permitted to access the input data 114 uploaded by the content creators 156 and/or the profiles of the content creators 156. In some embodiments, the non-transitory computer-executable instructions 112 may, when executed by the first computer 102(1), cause the first computer 102(1) to determine that a consumer 118 selected, such as via the third computing device 102(3), the input data 114 uploaded by a content creator, such as via the leaderboard user interface 140 of the second web-based portal 128(2), and the first computer 102(1) can direct the second web-based portal 128(2) to the input data 114, thereby allowing the input data 114 to be played and/or displayed for the consumer 118 on the third computing device 102(3). For example, the first computing device 102(1) may receive a request by a consumer 118 from the third computing device 102(3) to output (e.g., play and/or display) the input data 114 (e.g., audio data, visual data, audiovisual data, or a combination thereof) uploaded by a content creator of the content creators 156, and the first computer 102(1) may cause the input data 114 to be output on the audio output devices 124, video output devices 136, or a combination thereof of the third computer 102(3), for the third computer 102(3) to collect the consumer interactions 136 with the input data 114 and send the consumer interactions 136 to the first computer 102(1). In another embodiment, the non-transitory computer-executable instructions 112 may, when executed by the first computer 102(1), cause the first computer 102(1) to determine that a consumer 138 selected, such as via the third computing device 102(3), the identifier of a content creator, such as via the leaderboard user interface 140, and the first computer 102(1) can direct the second web-based portal 128(2) to the identified content creator's profile.

In the example embodiment of FIG. 3B, a plurality of consumers 148 can each receive the input data 114 uploaded by the content creators 156 and interact with the input data 114 via a respective user computing device of a plurality of user computing devices 152(1)-152(N) each with a graphical user interface 150(1)-150(N) displayed via the second web-based portal 128(2). For example, there may be a plurality of consumers 148 each with a user computing device similar to the third computing device 102(3) with a web-based portal that displays a graphical user interface that allows the consumers 148 to receive the input data 114 uploaded by the content creators 156 and interact with the input data 114, such as by commenting on the input data, sharing the input data to at least one or more additional consumers using the platform, “liking” or otherwise providing a non-written comment of approval or disapproval of the input data 114, or a combination thereof. The non-transitory computer-executable instructions 112 can, when executed by the first computer 102(1), cause the first computer 102(1) to calculate the number of these interactions from the consumers 148 for each of the input data 114 uploaded by each of the content creators 156 to calculate the number of consumer interactions 136 with each of the input data 114.

Exemplary methods of secure communication can be used between two or more computers of the system 100. Different embodiments of these exemplary methods can be implemented depending on the particular implementation details of the system 100. Furthermore, the order in which the steps of the method are presented is not intended to imply a required sequence for the steps. Rather, the steps can be implemented in a different sequence, and/or some or all of the steps can be implemented simultaneously.

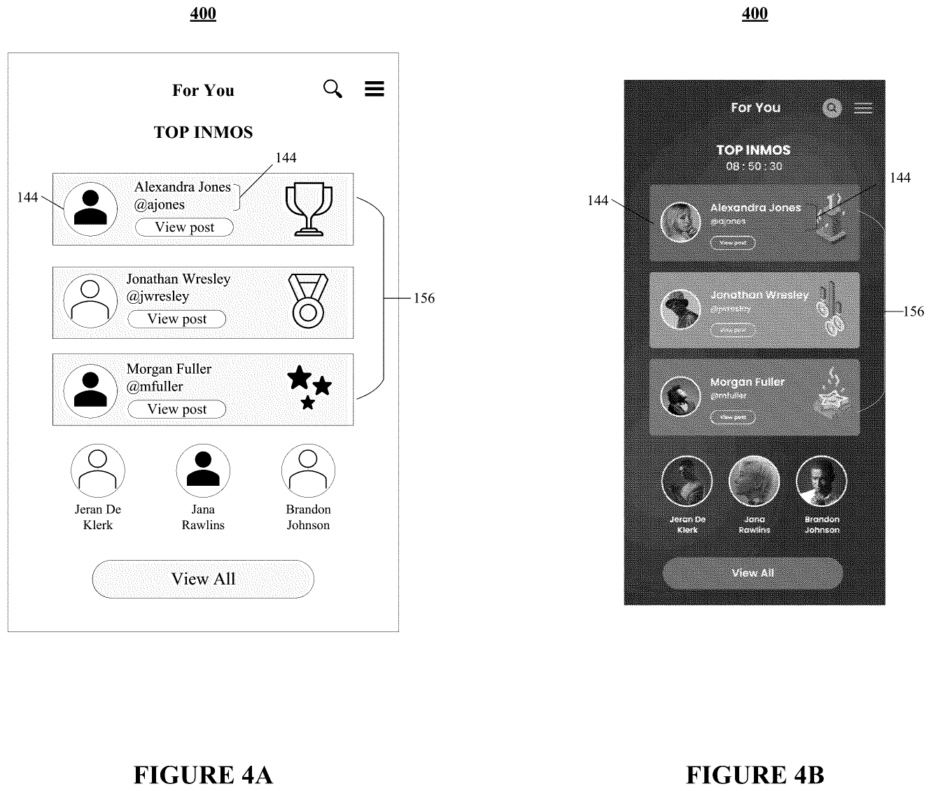

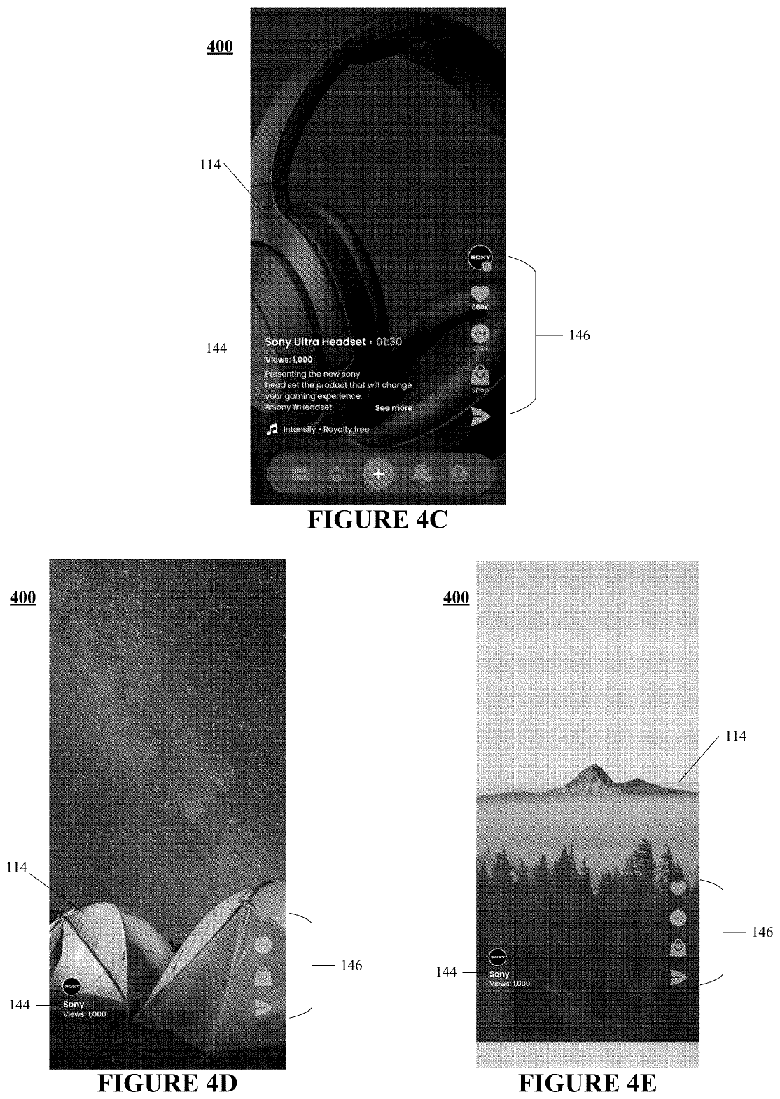

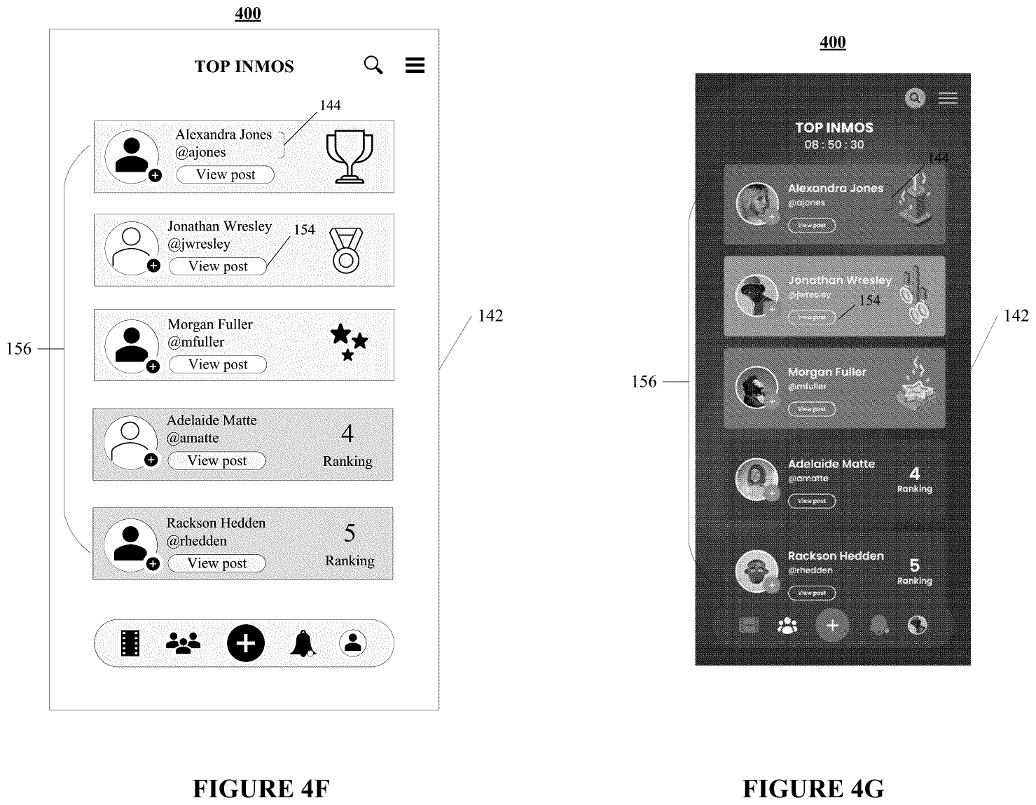

FIGS. 4A-4E provide serial views of a social media platform under one embodiment of the present disclosure. The digital platform may be a social media platform 400 with a leaderboard functionality, and the users of the platform 400 can comprise content creators 156, content consumers 148, or a combination thereof. The social media platform 400 can provide a display of the content creators 156, such as a group of content creators from among the content creators 156 with a higher leaderboard rank value 140 than other content creators. The display on the social media platform 400 can include identifiers 144 for the content creators, such as the content creators' profile picture, name, and/or handle. For example, the illustrated display may be implemented via the graphical user interface 130(1) on the second computing device 102(2) for the content creators 156 and/or the graphical user interface 130(2) on the third computing device 102(3) for the consumers 148. The social media platform 400 can also provide a display of content (e.g., input data 114) uploaded by the content creators 156 and allow for the consumers 148 to interact with the content via icons 146 to provide the consumer interactions 136, such as by commenting on the content, sharing the content to additional consumers, “liking” or otherwise providing a non-written comment of approval or disapproval of the content, or a combination thereof.

FIGS. 4F-4G illustrate a leaderboard user interface under one embodiment of the present disclosure. As can be seen in this exemplary embodiment, the leaderboard user interface 142 can display the top five content creators from among the content creators 156 in descending order from the highest leaderboard rank value 140 to a next lower leaderboard rank value 140. In some embodiments, the leaderboard user interface 142 can display the top 10 content creators, the top 5 content creators, the top 3 content creators, the top content creator, or a combination thereof.

The leaderboard user interface 142 can be displayed through the first web-based portal 128(1), the second web-based portal 128(2), or a combination thereof, wherein a higher leaderboard rank value 140 receives more recognition than a lower leaderboard rank value 140, thereby incentivizing the content creators 156 to create or upload creative or original content to the digital platform 400. The leaderboard user interface 142 can include a means for a user, such as a consumer 118, to access the input data 114 uploaded by a content creator, a content creator's profile, or both, such as by clicking on the input data 114 or an icon or link to the content creator's profile (e.g., the “View post” button 154 to view the input data 114 updated by the respective content creator). The leaderboard user interface 142 can also include categories, such as a subject matter of the input data 114 uploaded by the content creators 156, a location of a content creator, a location of the input data 114 uploaded by the content creators 156, or a combination thereof, such as subject matter categories which may include topics commonly of interest to one or more users like sports, music, entertainment, consumer products, or vehicles. The leaderboard user interface 142 can display one or more of the input data 114 uploaded by at least one of the content creators 156, an identifier 144 associated with at least one of the content creators 156, such as the content creator's name, or a combination thereof. When the consumer 118 selects the input data 114 uploaded by at least one of the content creators 156, the second web-based portal 128(2) can be directed to display the input data 114. When the consumer 118 selects the identifier 144 associated with at least one of the content creators 156, such as the content creator's name, the second web-based portal 128(1) can be directed to display the content creator's profile.

In certain embodiments, the leaderboard user interface 142 can display the leaderboard rank value 140 for up to 100 of the content creators 156. In embodiments, the leaderboard user interface 142 can display the leaderboard rank value 140 for up to 90 content creators, up to 80 content creators, up to 70 content creators, up to 60 content creators, up to 50 content creators, up to 40 content creators, up to 30 content creators, up to 20 content creators, up to 10 content creators, or a combination thereof.

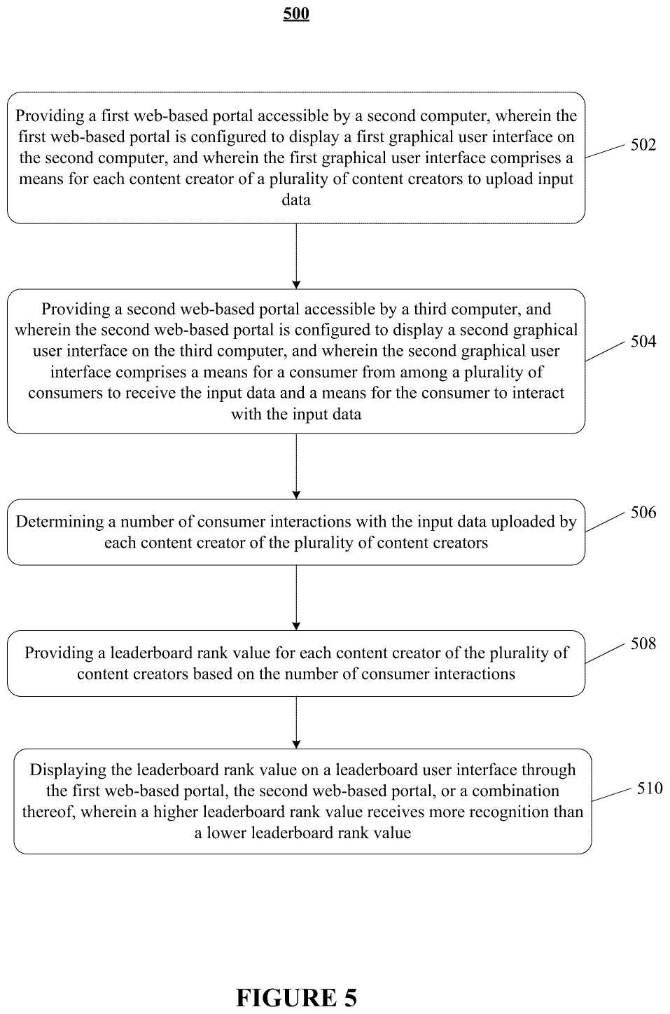

FIG. 5 is a flowchart diagram depicting one embodiment of a method 500 of the present disclosure. In certain embodiments, the method 500 of generating and displaying a leaderboard user interface may include the step of providing one or more memories 110. The memories 110 may store non-transitory computer-executable instructions 112 for generating and displaying a leaderboard user interface 142. The memories 110 may also store input data 114.

The method 500 may include the step of providing a first computer 102(1) with at least one processor 104 for executing the non-transitory computer-executable instructions 112. The method 500 may include the step of executing, by the first computer 102(1), the non-transitory computer-executable instructions 112 to perform operations. The method 500 may include operation 502 of providing a first web-based portal 128(1) that is accessible by a second computer 102(2) and configured to display a first graphical user interface 130(1) on the second computer 102(2). The second computer 102(2) may include one or more input devices 120. The first graphical user interface 130(1) may include a means for each content creator from among the content creators 156 to upload input data 114. For example, the input data 114 may include audio data, visual data, audiovisual data, or a combination thereof.

The method 500 may include operation 504 of providing a second web-based portal 128(2) that is accessible by a third computer 102(3) and configured to display a second graphical user interface 130(2) on the third computer 102(3). The third computer 102(3) may include one or more audio output devices 124, video output devices 126, or a combination thereof. The second graphical user interface 130(2) may include a means for a consumer 118 from among a plurality of consumers 148 to receive the input data 114 and interact with the input data 114.

The method 500 may include operation 506 of determining a number of consumer interactions 136 with the input data 114 uploaded by each of the content creators 156. The method 500 may further include the step of calculating the number of consumer interactions 136 with the input data 114 uploaded by each content creator of the plurality of content creators 156 over a predetermined period of time, such as any time between about 1 hour and about 24 hours. The method 500 may include the step of assessing one or more of the number of consumer interactions 136 with the input data 114 uploaded by each content creator, a quality of the consumer interactions 136 with the input data 114 uploaded by each content creator, a level of creativity of the input data 114 uploaded by each content creator, a level of originality of the input data 114 uploaded by each content creator, or a combination thereof. For example, the method 500 may include the step of evaluating one of the plurality of input data 114 uploaded by the content creators 156 for a level of creativity.

The method 500 may include operation 508 of providing a leaderboard rank value 140 for each of the content creators 156 based on the number of consumer interactions 136. The leaderboard rank value 140 for a content creator of the content creators 156 may be directly proportional to one or more of the number of consumer interactions 136 with the input data 114 uploaded by the content creator, the quality of the consumer interactions 136 with the input data 114 uploaded by the content creator, the level of creativity of the input data 114 uploaded by the content creator, the level of originality of the input data 114 uploaded by the content creator, or a combination thereof. For example, the level of creativity of the input data 114 can be rewarded by providing the creator or poster of the input data 114 (e.g., the applicable content creator) with a given leaderboard rank value 140 on the leaderboard user interface 142, wherein the leaderboard rank value 140 may be directly proportional to the level of creativity. Providing the leaderboard rank value 140 for each of the content creators 156 based on the number of consumer interactions 136 may include comparing the number of consumer interactions 136 with the input data 114 uploaded by each of the content creators 156 and ranking the content creators 156 based on the number of consumer interactions 136 with the input data 114 uploaded by each of the content creators 156, and the higher leaderboard rank value 140 can be assigned to the content creator with a higher number of consumer interactions 136 with their input data 114 than the number of consumer interactions 136 with the input data 114 uploaded by another content creator. The leaderboard rank value 140 may be assigned to the content creator and/or the input data 114 uploaded by the content creator. In certain embodiments, the leaderboard rank value 140 can be provided for up to 1,000 of the content creators 156.

The method 500 may include operation 510 of displaying the leaderboard rank value 140 on a leaderboard user interface 142 through the first web-based portal 128(1), the second web-based portal 128(2), or a combination thereof, wherein a higher leaderboard rank value 140 receives more recognition than a lower leaderboard rank value 140, thereby incentivizing the content creators 156 to create or upload creative or original content (e.g., input data 114) to the digital platform. The leaderboard user interface 142 can include a means for a user, such as a consumer 118, to access the input data 114 uploaded by a content creator, a content creator's profile, or both, such as by clicking on the input data 114 or an icon or link to the content creator's profile. The leaderboard user interface 142 can also include categories, such as a subject matter of the input data 114 (e.g., content) uploaded by the content creators 156, a location of a content creator, a location of the input data 114 uploaded by the content creators 156, or a combination thereof. The categories allow users of the digital platform (e.g., consumers 148) to selectively access content (e.g., input data 114) that relates to the particular user's interests, such as a subject matter category which may include topics that are commonly of interest to one or more users like sports, music, entertainment, consumer products, or vehicles. The leaderboard user interface 142 can display one or more of the input data 114 uploaded by at least one of the content creators 156 or an identifier associated with at least one of the content creators 156, such as the content creator's name, or a combination thereof. The method 500 may include the step of determining that the consumer selected the input data 114 uploaded by the at least one of the content creators 156 and directing the second web-based portal 128(2) to the input data 114 uploaded by the at least one of the content creators 156. The method 500 may additionally include the step of determining that the consumer selected the identifier associated with the at least one of the content creators 156, such as by selecting the content creator's name, and directing the second web-based portal 128(1) to the content creator's profile.

In certain embodiments, the leaderboard user interface 142 can display the leaderboard rank value 140 for up to 100 of the content creators 156. In embodiments, the leaderboard user interface 142 can display the leaderboard rank value 140 for up to 90 content creators, up to 80 content creators, up to 70 content creators, up to 60 content creators, up to 50 content creators, up to 40 content creators, up to 30 content creators, up to 20 content creators, up to 10 content creators, or a combination thereof. The leaderboard user interface 142 can display the top 10 content creators, the top 5 content creators, the top 3 content creators, the top content creator, or a combination thereof.

In some embodiments, the non-transitory computer-executable instructions 112 may, when executed by the first computer 102(1), cause the first computer 102(1) to determine leaderboard statistics for each of the content creators 156 and display the leaderboard statistics for at least one of the content creators 156 on a user computing device, such as a computing device associated with one or more of a content creator, a consumer, a third-party marketer, or a digital platform provider, via a web-based portal and/or graphical user interface, such as the leaderboard user interface 142.

In embodiments, the level of creativity of the input data 114 may be rewarded by transferring ownership rights 138 in one or more digital assets 134 stored on a blockchain 132 to the content creator based on the number of consumer interactions 136 with the input data 114. The one or more digital assets 134 may include data about the digital assets 134, such as a digital asset identification number or information about the input data 114. The digital assets 134 can include a non-fungible token (NFT). The method 500 may include the step of providing ownership rights 138 in one or more tokens (e.g., NFTs) to the content creator 116, wherein the number of tokens in which the content creator 116 obtains ownership rights 138 may be directly proportional to one or more of the number of interactions 136 with the content creator's input data 114, the quality of interactions 136 with the content creator's input data 114, the level of creativity in the content creator's input data 114, the level of originality in the content creator's input data 114, or a combination thereof. In embodiments, the ownership rights 138 in one or more tokens can be transferred to the content creator 116 via executing a smart contract. The method 500 may further include the steps of converting at least a portion of the input data 114 into the digital assets 134 and storing the converted digital assets on the blockchain 132. The method 500 may also include the step of recording the transfer of the ownership rights 138 in the digital assets 134 on the blockchain 132 after such transfer of the digital assets 134. Recording the transfer of the ownership rights 138 may include creating a new block on the blockchain 132 that includes data about the transfer, such as a date, a time, a price, a previous owner, a new owner, or an identification of the digital assets 134.

In some implementations, the systems and methods disclosed herein include a second computer 102(2), such as a user computer, wherein the second computer 102(2) is a content creator's computer or a computer through which a content creator uses to access the digital platform disclosed herein. In such implementations, the method 500 can comprise providing a web-based portal 128(1) accessible by the content creator's computer (e.g., the second computer 102(2)), and displaying a graphical user interface 130(1) on the content creator's computer display where the content creator can upload the input data 114. The step of assigning the leaderboard rank value 140 to the input data 114, the applicable content creator (e.g., the content creator who uploaded input data 114), or a combination thereof, can be performed through the web-based portal 128(1). Certain embodiments comprise a step of displaying a leaderboard user interface 142 via the web-based portal 128(1), wherein the leaderboard user interface 142 displays the relative leaderboard rank value 140 of a plurality of content creators 156. A higher leaderboard rank value 140 can receive more recognition than a lower leaderboard rank value 140, thereby incentivizing the plurality of content creators 156 to create or upload creative or original content to the digital platform. Similarly, in embodiments, the step of transferring ownership rights in the digital asset via a smart contract can be performed through the web-based portal 128(1).

In some implementations, the systems and methods disclosed herein include a third computer 102(3), such as a user computer, wherein the third computer 102(3) is a consumer's computer or a computer through which a consumer uses to access the digital platform disclosed herein. In such implementations, the method 500 can comprise providing a web-based portal 128(2) accessible by the consumer's computer (e.g., the third computer 102(3)), and displaying a graphical user interface 130(2) on the consumer's computer display where the consumer can receive the input data 114 and interact with the input data 114. The method 500 may include the steps of receiving a request to play or display certain input data 114 (such as audio data, visual data, or audiovisual data uploaded by a content creator of the content creators 156) and playing or displaying the requested input data 114 through the audio and/or video output devices of the third computer 102(3). After viewing, hearing, or otherwise accessing the input data 114, a consumer 118 can then interact with the input data 114 as further described above. Embodiments can further include the step of displaying the leaderboard user interface 142 on the third computer 102(3) and permitting the consumer 118 to interact with the leaderboard user interface 142, such as by clicking on any input data 114 or content creator names that are displayed therein or a combination thereof. In embodiments, when a consumer 118 clicks on the input data 114 or a content creator name, the web-based portal 128(2) can be redirected to the input data 114 or the particular content creator's profile.

In embodiments, the one or more memories 110 can store non-transitory computer-executable instructions 112 for generating and displaying a leaderboard user interface 142 on any one or more of the first computer 102(1), the second computer 102(2), and the third computer 102(3).

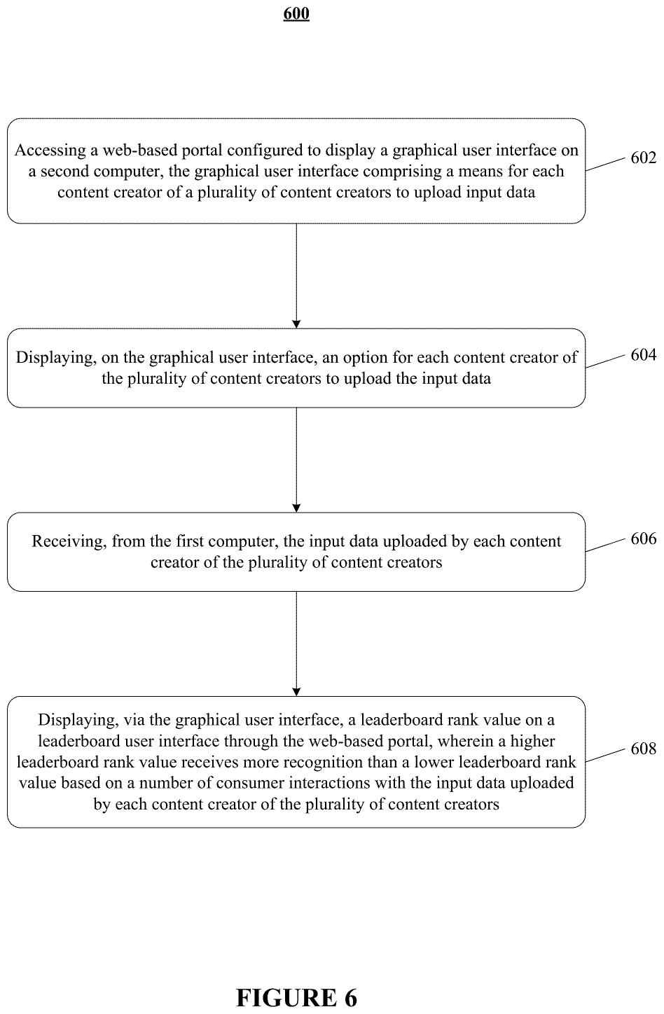

FIG. 6 is a flowchart diagram depicting one embodiment of a method 600 of the present disclosure. In certain embodiments, the method 600 of generating and displaying a leaderboard user interface may include the step of providing one or more memories 110. The memories 110 may store non-transitory computer-executable instructions 112 for generating and displaying a leaderboard user interface 142. The memories 110 may also store input data 114.

The method 600 may include the step of providing a first computer 102(1) with at least one processor 104 for executing the non-transitory computer-executable instructions 112. A second computer 102(2) may be provided that includes one or more input devices 120 and at least one processor for executing the non-transitory computer-executable instructions 112. The second computer 102(2) may be a user computer associated with a content creator of the plurality of content creators 156. The method 600 may include the step of executing, by the second computer 102(2), the non-transitory computer-executable instructions 112 to perform operations. The method 600 may include the step of executing, by the second computer 102(2), the non-transitory computer-executable instructions 112 to perform operations. The method 600 may include operation 602 of accessing a web-based portal 128(1) configured to display a graphical user interface 130(1) on the second computer 102(2), the graphical user interface 130(1) comprising a means for each content creator of a plurality of content creators 156 to upload input data 114.

The method 600 may include operation 604 of displaying, on the graphical user interface 130(1), an option for each content creator of the plurality of content creators 156 to upload the input data 114. The method 600 may include operation 606 of receiving, from the first computer 102(1), the input data 114 uploaded by each content creator of the plurality of content creators 156. The method 600 may include operation 608 of displaying, via the graphical user interface 130(1), a leaderboard rank value 140 on a leaderboard user interface 142 through the web-based portal 128(1), wherein a higher leaderboard rank value 140 receives more recognition than a lower leaderboard rank value 140 based on a number of consumer interactions 136 with the input data 114 uploaded by each content creator of the plurality of content creators 156.

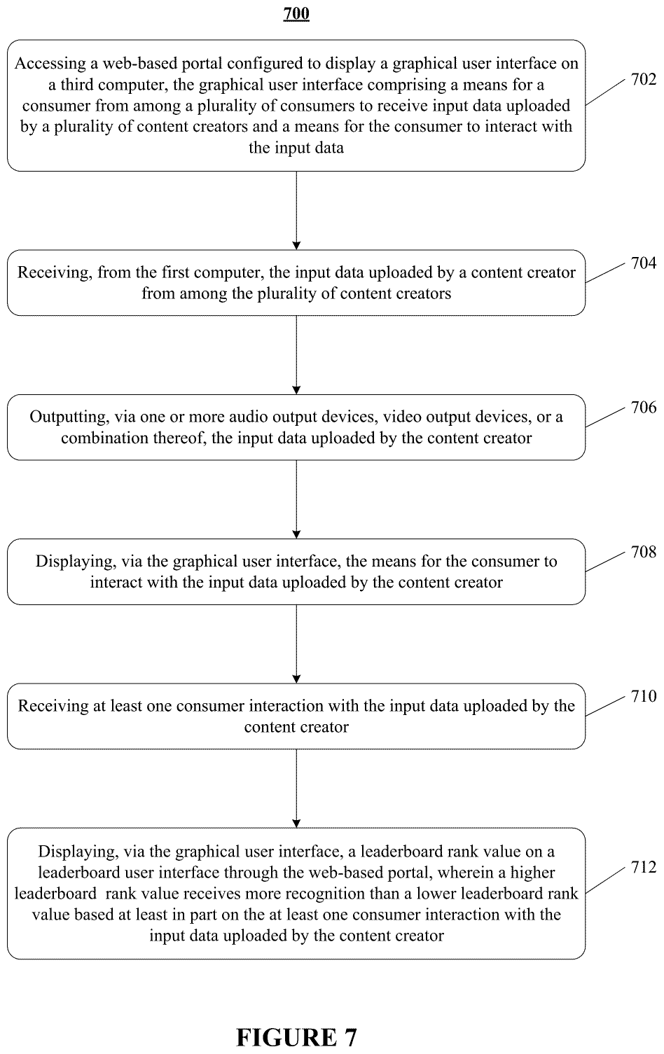

FIG. 7 is a flowchart diagram depicting one embodiment of a method 700 of the present disclosure. In certain embodiments, the method 700 of generating and displaying a leaderboard user interface may include the step of providing one or more memories 110. The memories 110 may store non-transitory computer-executable instructions 112 for generating and displaying a leaderboard user interface 142. The memories 110 may also store input data 114.

The method 700 may include the step of providing a first computer 102(1) with at least one processor 104 for executing the non-transitory computer-executable instructions 112. A second computer 102(2) may be provided that includes one or more input devices 120. A third computer 102(3) may be provided that includes one or more audio output devices 124, video output devices 126, or a combination thereof, and at least one processor for executing the non-transitory computer-executable instructions 112. The second computer 102(2) may be a first user computer associated with a content creator 116 and the third computer 102(3) may be a second user computer associated with a consumer.

The method 700 may include the step of executing, by the third computer 102(3), the non-transitory computer-executable instructions 112 to perform operations. The method 700 may include operation 702 of accessing a web-based portal 128(2) configured to display a graphical user interface 130(2) on the third computer 102(3), the graphical user interface 130(2) comprising a means for a consumer from among a plurality of consumers 148 to receive input data 114 uploaded by a plurality of content creators 156 and a means for the consumer to interact with the input data 114.

The method 700 may include operation 704 of receiving, from the first computer 102(1), the input data 114 uploaded by a content creator from among the plurality of content creators 156. The method 700 may include operation 706 of outputting, via the one or more audio output devices 124, video output devices 126, or a combination thereof, the input data 114 uploaded by the content creator. The method 700 may include operation 708 of displaying, via the graphical user interface 130(2), the means for the consumer to interact with the input data 114 uploaded by the content creator. The method 700 may include operation 710 of receiving at least one consumer interaction 136 with the input data 114 uploaded by the content creator. The method 700 may include operation 712 of displaying, via the graphical user interface 130(2), a leaderboard rank value 140 on a leaderboard user interface 142 through the web-based portal 128(2), wherein a higher leaderboard rank 140 value receives more recognition than a lower leaderboard rank value 140 based at least in part on the at least one consumer interaction 136 with the input data 114 uploaded by the content creator.

The presently disclosed systems and methods have a wide application anywhere in the computer industry where the generation and transfer of digital assets or the displaying of a ranked-based leaderboard is needed. One particularly important application for the systems and methods described herein relates to creation and transfer of digital assets in exchange for popular or creative content (such as input data) on digital platforms such as social media platforms. Additional systems and methods include the creation and display of a leaderboard for a plurality of content creators, wherein any one content creator's given rank is directly proportional to the popularity or creativity of the content creator's input data on digital platforms such as social media platforms. However, the systems and methods described above could be utilized in other contexts.

### EXAMPLES

### Example 1

Over 50 million people consider themselves creators. The freedom of expression along with the desire to leave the traditional 9-5 behind have resulted in today's creator economy. People are seeking to turn their passions into professions.

However, even with all the effort and time put into content creation, the prospect of a reward as an “influencer” is diminishing. Here are a few non-limiting reasons why:

Competition—gone are the days when posting high-quality photos was enough. The market is so saturated, and original content is not always rewarded.

Burnout—the pressure to produce content can be overwhelming, and with no real prompt or guides, it can cause influencers to regurgitate content rather than create something original, especially when original content does not earn the growth and engagement they are hoping for.

Algorithms—the current social media platforms have ever-changing algorithms, making it increasingly difficult for creators to get their content seen.

Inconsistencies in how to earn an income—not only is influencers' income regularly tied to brand deals and sponsorships, but also the social media platforms themselves are regularly pausing or changing the bonus structure they offer, making it difficult to earn an income.

The systems and methods disclosed herein operate differently than prior social media platforms. The presently disclosed systems and methods value authenticity and original content above all else, and are configured to heighten the reward for creators. In embodiments, the systems and methods disclosed herein include a fully monetized social media app. In the exemplary app, it pays to be original. Unlike traditional social media platforms, the presently disclosed platform rewards creators for the creator's content (or input data) directly, building a sustainable ecosystem for content creators. In various embodiments, the presently disclosed platform provides creators with the tools they need to thrive.

### Example 2

In various exemplary embodiments, the leaderboard functionality disclosed herein is provided in association with a social media digital platform. This leaderboard functionality can be provided as an alternative to or in addition to a token-based system of rewarding content creators for input data that is well-received by a plurality of consumers.

Embodiments also include the non-transitory computer-executable instructions for tallying the number of interactions on a content creator's posts every 24 hours and comparing such number of interactions to those of other content creators when it comes to virality. In embodiments, only the quantity of a non-written comment of approval (such as the number of “likes”) for certain input data are considered in assigning the content creator's given rank on the leaderboard. Thus, under such embodiments, the more likes on a certain input data, the higher the rank assigned to the content creator on the leaderboard.

In embodiments, the leaderboard assists platform providers or other third parties, such as consumers, in discovering or rewarding the most original, most creative, or most popular content creators on the digital platform.

The leaderboard functionality can permit daily challenges that are created by the platform provider or users of the digital platform.

Under certain embodiments, the leaderboard permits users to view a given content creator's profile or provide a link to view a given post.

In some embodiments, the leaderboard is broken down into different categories for ease of searching and ease of consumption by users of the platform. For instance, such categories can comprise sports, music, entertainment, geographic regions, or a combination thereof.

### An App for Creators

Embodiments of the present disclosure comprise a fully monetized digital platform for all creators to showcase their original content and get paid. Certain embodiments are available across a plurality of operating platforms for use on any mobile device or computer. Embodiments are available for IOS and Android platforms.

The presently disclosed digital platform includes a content creation app, wherein content creators keep all the money earned through engagements and interactions on the app.

In various embodiments, the presently disclosed platform is configured to inspire endless creativity and collaboration with other users and content creators.

Certain embodiments permit content creators to challenge other creators to healthy competition and go head-to-head to earn NFTs.

In one embodiment, the presently disclosed systems and methods include a completely monetized platform using its own version of data assets (such as an NFT) as the currency. In embodiments, spending and earning such data assets allows for content, creativity, and payouts to flow between content creators.

A method of monetizing short-form content is also disclosed herein. In embodiments, the amount the creator earns is directly proportional to third-party user engagement with any content that the creator uploads to a social media platform.

### EQUIVALENTS

Those skilled in the art will recognize, or be able to ascertain, using no more than routine experimentation, numerous equivalents to the specific substances and procedures described herein. Such equivalents are considered to be within the scope of this disclosure and are covered by the following exemplary claims.

What is claimed is:

1. A system for displaying a leaderboard user interface for content on a digital platform, the system comprising:
at least one memory storing non-transitory computer-executable instructions;
a first computer with at least one processor for executing the non-transitory computer-executable instructions;
a second computer with one or more input devices; and
a third computer comprising one or more audio output devices, video output devices, or a combination thereof;
wherein, when executed by the first computer, the non-transitory computer-executable instructions cause the first computer to perform operations comprising:
providing a first web-based portal accessible by the second computer, wherein the first web-based portal is configured to display a first graphical user interface on the second computer, and wherein the first graphical user interface comprises a means for each content creator of a plurality of content creators to upload input data;
providing a second web-based portal accessible by the third computer, wherein the second web-based portal is configured to display a second graphical user interface on the third computer, and wherein the second graphical user interface comprises a means for a consumer from among a plurality of consumers to receive the input data and a means for the consumer to interact with the input data;
determining a number of consumer interactions with the input data uploaded by each content creator of the plurality of content creators;
providing a leaderboard rank value for each content creator of the plurality of content creators based on the number of consumer interactions; and
displaying the leaderboard rank value on a leaderboard user interface through the first web-based portal, the second web-based portal, or a combination thereof, wherein a higher leaderboard rank value receives more recognition than a lower leaderboard rank value.

2. The system of claim 1, wherein the operations further comprise assessing one or more of the number of consumer interactions with the input data uploaded by each content creator, a quality of the consumer interactions with the input data uploaded by each content creator, a level of creativity of the input data uploaded by each content creator, or a level of originality of the input data uploaded by each content creator, wherein the leaderboard rank value is directly proportional to one or more of the number of consumer interactions, the quality of the consumer interactions, the level of creativity of the input data, the level of originality of the input data, or a combination thereof.

3. The system of claim 1, wherein providing the leaderboard rank value for each content creator of the plurality of content creators based on the number of consumer interactions comprises:
comparing the number of consumer interactions with the input data uploaded by each content creator of the plurality of content creators; and
ranking the plurality of content creators based on the number of consumer interactions with the input data uploaded by each content creator, wherein the higher leaderboard rank value is assigned to a content creator from among the plurality of content creators with a higher number of consumer interactions with the input data uploaded by the content creator than a number of consumer interactions with the input data uploaded by another content creator from among the plurality of content creators.

4. The system of claim 1, wherein the leaderboard rank value is assigned to one or more of the input data uploaded by a content creator from among the plurality of content creators or a content creator from among the plurality of content creators associated with the input data uploaded by the content creator.

5. The system of claim 1, wherein the leaderboard rank value is provided for up to 1,000 content creators from among the plurality of content creators.

6. The system of claim 1, wherein the leaderboard user interface displays one or more of the input data uploaded by at least one content creator from among the plurality of content creators, an identifier associated with at least one content creator from among the plurality of content creators, or a combination thereof.

7. The system of claim 6, wherein the operations further comprise:
determining that the consumer selected the input data uploaded by the at least one content creator; and
in response to determining that the consumer selected the input data uploaded by the at least one content creator, directing the second web-based portal to the input data uploaded by the at least one content creator.

8. The system of claim 6, wherein the operations further comprise:
determining that the consumer selected the identifier associated with the at least one content creator; and
in response to determining that the consumer selected the identifier associated with the at least one content creator, directing the second web-based portal to a profile associated with the at least one content creator.

9. The system of claim 1, wherein the leaderboard user interface comprises a means for a user to access the input data uploaded by a content creator from among the plurality of content creators, a profile associated with the content creator, or both.

10. The system of claim 1, wherein the leaderboard user interface comprises a plurality of categories, wherein the plurality of categories comprises one or more of a subject matter of the input data uploaded by the plurality of content creators, a location of a content creator from among the plurality of content creators, a location of the input data uploaded by the plurality of content creators, or a combination thereof.

11. The system of claim 1, wherein the leaderboard user interface is configured to display the leaderboard rank value for up to 100 content creators from among the plurality of content creators.

12. The system of claim 1, wherein the operations further comprise:
displaying the leaderboard user interface on the third computer via the second web-based portal; and
permitting the consumer from among the plurality of consumers to interact with the leaderboard user interface.

13. The system of claim 1, wherein the operations further comprise:
receiving, from the third computer, a request by a consumer to output the input data uploaded by at least one content creator from among the plurality of content creators, wherein the input data comprises one or more of audio data, visual data, audiovisual data, or a combination thereof;
outputting the input data uploaded by the at least one content creator via the one or more audio output devices, video output devices, or a combination thereof of the third computer; and
receiving, from the third computer, consumer interactions with the input data uploaded by the at least one content creator.

14. The system of claim 1, wherein the operations further comprise:
determining leaderboard statistics for each content creator of the plurality of content creators; and
displaying the leaderboard statistics for at least one content creator of the plurality of content creators on a user computing device.

15. The system of claim 14, wherein the user computing device comprises a computing device associated with one or more of a content creator, a consumer, a third-party marketer, or a digital platform provider.

16. The system of claim 1, wherein the operations further comprise calculating the number of consumer interactions with the input data uploaded by each content creator of the plurality of content creators over a predetermined period of time.

17. The system of claim 1, wherein the input data comprises one or more of audio data, visual data, audiovisual data, or a combination thereof.

18. The system of claim 1, wherein the digital platform comprises a social media platform.

19. A system for displaying a leaderboard user interface for content on a digital platform, the system comprising:
at least one memory storing non-transitory computer-executable instructions;
a first computer with at least one processor for executing the non-transitory computer-executable instructions; and
a second computer with one or more input devices;
wherein, when executed by the second computer, the non-transitory computer-executable instructions cause the second computer to perform operations comprising:
accessing a web-based portal configured to display a graphical user interface on the second computer, the graphical user interface comprising a means for each content creator of a plurality of content creators to upload input data;
displaying, on the graphical user interface, an option for each content creator of the plurality of content creators to upload the input data;
receiving, from the first computer, the input data uploaded by each content creator of the plurality of content creators; and
displaying, via the graphical user interface, a leaderboard rank value on a leaderboard user interface through the web-based portal, wherein a higher leaderboard rank value receives more recognition than a lower leaderboard rank value based on a number of consumer interactions with the input data uploaded by each content creator of the plurality of content creators.

20. A system for displaying a leaderboard user interface for content on a digital platform, the system comprising:
at least one memory storing non-transitory computer-executable instructions;
a first computer with at least one processor for executing the non-transitory computer-executable instructions;
a second computer with one or more input devices; and
a third computer comprising one or more audio output devices, video output devices, or a combination thereof;
wherein, when executed by the third computer, the non-transitory computer-executable instructions cause the third computer to perform operations comprising:
accessing a web-based portal configured to display a graphical user interface on the third computer, the graphical user interface comprising a means for a consumer from among a plurality of consumers to receive input data uploaded by a plurality of content creators and a means for the consumer to interact with the input data;
receiving, from the first computer, the input data uploaded by a content creator from among the plurality of content creators;
outputting, via the one or more audio output devices, video output devices, or a combination thereof, the input data uploaded by the content creator;
displaying, via the graphical user interface, the means for the consumer to interact with the input data uploaded by the content creator;
receiving at least one consumer interaction with the input data uploaded by the content creator; and
displaying, via the graphical user interface, a leaderboard rank value on a leaderboard user interface through the web-based portal, wherein a higher leaderboard rank value receives more recognition than a lower leaderboard rank value based at least in part on the at least one consumer interaction with the input data uploaded by the content creator.
